(19) United States
(12) Patent Application Publication
(10) Pub. No.: US 2016/0203900 A1
(43) Pub. Date: Jul. 14, 2016

(54) AN ELECTRICAL RELAY DRIVE ARRANGEMENT FOR ENERGISING AND DE-ENERGISING THE ELECTRICAL COIL OF AN ELECTRO-MECHANICAL RELAY

(71) Applicant: HENDON SEMICONDUCTORS PTY LTD, Hendon, South Australia (AU)

(72) Inventors: Paul Bourne, Hendon (AU); Matthew Cook, Hendon (AU)

(21) Appl. No.: 14/911,170

(22) PCT Filed: Aug. 7, 2014
(86) PCT No.: PCT/AU2014/000782

§ 371 Date: Feb. 9, 2016

(30) Foreign Application Priority Data
Aug. 9, 2013 (AU) 2013903000

(51) Int. Cl. H01F 7/06; H01H 47/32

(52) U.S. Cl. CPC H01F 7/064; H01H 47/32

(57) ABSTRACT

An electrical relay driver arrangement for energising and de-energising an electrical coil of an electro-mechanical relay including a power supply controller adapted to provide outputtable voltage at definable intervals approaching or about zero crossing to charge a capacitor arrangement to a selectable voltage in communication with a resistor to provide an available current. A micro-controller adapted to provide a boost current such that when the electrical coil of the electro-mechanical relay is to be energised, the electrical coil initially receives the boost current at and for a time interval set by the micro-controller and thereafter from the available current provided through a transistor receiving a control signal from the power supply controller.

### FIELD OF THE INVENTION

This invention relates to an improved electrical relay driver arrangement which is adapted to energise and de-energise the electrical coil of an electro-mechanical relay so as to actuate and maintain the physical pulling together or separation of the mechanical contact electrodes so as to engage or disengage AC mains supply to a load circuit.

More particularly this invention relates to improvements that will provide energy efficiency and optimisation in the operation of the electrical relay driver itself and also improving the longevity and integrity of the mechanical contact electrodes of the electro-mechanical relay.

### BACKGROUND ART DISCUSSION

For the most part an electromechanical relay includes a coil which upon being energised, establishes a magnetic field that is able to pull a moveable contact electrode into physical engagement with a stationary mechanical contact electrode in a normally open relay in order to complete the electrical circuit between the power terminals of AC mains supply or alternatively if the relay is in a normally closed configuration, the energising of the coil creates a magnetic field which will separate the physical contact of the two contact electrodes consequently opening the electrical circuit between the power terminals of the AC mains supply.

For the most part this invention relates to both normally opened and normally closed relays, in that the focus of the invention is as to how the electrical relay driver arrangement is able to energise and/or de-energise as the case may require to establish the requirement of disengaging or physically pulling together the mechanical contact electrodes of the electro-mechanical relay.

The intention of this invention is provide a unique way in which the electrical coil of the electro-magnetic relay can be energised so as to maximise overall energy efficiency of both the electrical relay driver and the electro-mechanical relay per se while at the same time provide a mechanism whereby optimum longevity and life expectancy of the relay can be achieved.

While the electrical relay driver functions to energise and de-energise the electrical coil of the electrical relay, it must provide or obtain a power source in order to energise the coil in order to establish the requisite magnetic field.

It would be advantageous to be able to utilise AC mains supply, preferably the same AC mains supply to which the load circuit of the electrical magnetic relay controls to assist in this power supply to the electrical coil of the electro-mechanical relay.

It would be advantageous to be able to utilise AC mains voltage supply but to do so without the requirement of more conventional means such as linear line regulators which, while they may be able to maintain desired output voltages suitable for operation of the relay, in order to achieve this there is significant dissipating of excess power in the form of heat and hence maximum overall efficiency in voltage out to voltage in, is generally unacceptable since the volt difference is wasted.

Still further while the use of step down transformers and switch mode power supply switches attempt to provide suitable output voltages from the AC mains voltage supply, the actual continuous supply of output voltage in order to ultimately energise the electrical coil of the electrical mechanical relay may not be the optimum way in which coils can be efficiently energised and still maintain that appropriate pulling and/or separation between mechanical contact electrodes of the electro-mechanical relay to engage or disengage the load circuit from the AC mains voltage supply.

Therefore it would be particularly advantageous to be able to provide an electrical relay driver arrangement that could directly drive the electrical coil of an electro-mechanical relay without generating any significant excess electrical power in the form of heat so as to establish maximum power efficiency in voltage out to voltage in and at the same time also reduce power consumption while the electrical coil is being energised thereby reducing operating temperatures of the circuit components improving life expectancy of the electro-mechanical relay.

It is an object of this invention to provide such an improved electrical relay driver.

Further objects and advantages of the invention will become apparent from a complete reading of the specification.

### SUMMARY OF THE INVENTION

In one form of the invention there is provided an electrical relay driver arrangement for energising and de-energising the electrical coil of an electro-mechanical relay, said arrangement including;

a power supply controller adapted to receive rectified AC mains voltage supply, said power supply controller including logic functionality and/or adapted to provide outputtable voltage at definable intervals approaching or about zero crossing;

said outputtable voltage at definable intervals approaching or about zero crossing adapted to charge a capacitor arrangement to a selectable voltage, said capacitor arrangement in communication with a resistor to provide an available current, said power supply controller further including an output to provide a control signal to a transistor, said transistor upon receiving said control signal from said power supply controller provides the available current to an electrical coil of the electro-mechanical relay;

a micro-controller including internal logic functionality and/or adapted to provide a boost current adapted to energise the electrical coil of the electro-mechanical relay at a determined time whereby mechanical contact electrodes of the electro-mechanical relay are pulled together at a zero crossing of AC mains voltage supply interval of a load circuit being driven by the electrical relay driver arrangement;

such that when the electrical coil of the electro-mechanical relay is to be energised, the electrical coil initially receives the boost current at and for a time interval set by the micro-controller and thereafter from the available current provided through the transistor receiving the control signal from the power supply controller.

In preference the capacitor arrangement is a single capacitor or a plurality of capacitors in parallel.

An advantage of such an arrangement is that by energising the electrical coil effectively in two seamless stages by firstly actuating the energising process through the micro-controller which through a determined time interval when the mechanical contact electrodes need to be physically pulled together or separated means that the initial engagement of the mechanical contact electrodes will be done so at or during a zero crossing of AC mains voltage supply so that when the load circuit is connected or disengaged through movement together or away of the mechanical contact electrodes, voltage levels are as low as possible thereby minimising arcing which occurs during relay closing and opening.

The initial energising of the electrical coil of the electro-mechanical relay is determined by the micro-controller to avoid any contact degradation of the mechanical contact electrodes, once contact has been achieved the supply of current continues by virtue of the power supply controller outputted voltage made available at the defined interval approaching and/or about zero crossing.

Therefore the electrical coil after the initial boost current controlled by the microcontroller from then on for the most part is being energised through the available current by the series of established pulses of current that are made available from voltage derived only at that time interval from the power supply controller when measured AC mains voltage supply is about or approaching zero crossing.

Therefore while in a sense the electrical relay driver arrangement is energising the electrical coil at AC mains voltage supply zero crossings, this connection is only made subsequent to the initial energising which was established through the Boost current controlled by the micro-controller which does not actually send the energising current at precisely a zero crossing, but at a determined time interval such that mechanical engagement of the mechanical contact electrodes of the load circuit is made at that opportune moment of a zero crossing of an AC mains voltage supply taking into consideration of the lag time defined by the required physical pulling together of the mechanical contact electrodes of the electro-mechanical relay.

Accordingly while the relay may be driven directly by AC mains voltage supply, it is in fact only drawing power from the AC mains voltage supply at close to zero crossing of the AC mains supply as these pulses of current are made available at these time intervals at close to or about zero crossing and when the coil needs to be energised arrangement is such that the micro-controller will initially actuate the energising of the coil through the boost current but then subsequent maintenance of power to energise the coil will come through the available current by way of pulses from the power supply controller which is taking outputtable voltage definable at intervals close or there about the zero crossing as it measures the incoming AC mains voltage supply.

In preference the electrical relay driver arrangement includes a capacitor in parallel with the electrical coil of the electro-mechanical rely adapted to smooth out available current.

Advantageously as current is only sourced from the output voltage of the power supply controller at definable intervals approaching or about zero crossing means that there is no dissipating excess power and hence there is a maximum power efficiency in voltage out as opposed to voltage in with little wastage losses.

Still further, as current is supplied in pulses that will ultimately be responsible for energising the electrical coil, there is not a continuous output voltage which one would normally expect when including conventional linear regulation of step down transformers and switch mode power supply switches that would provide or at least establish an operable active continuous output voltage which conventional electro-mechanical relay arrangement would require in order to maintain energisation of the electrical coil while the magnetic field needs to be maintained.

Advantageously as there is reduced power consumption while the electrical coil is being energised this reduces the operating temperatures of the components of the electrical relay, increasing life expectancy as well as optimising energy efficiency.

In preference voltage in for the power supply controller is taken directly from the rectified AC mains voltage supply through a series of resistors.

In preference the power supply controller charges the single or each capacitor in parallel of the capacitor arrangement to a defined voltage.

In preference the single or each capacitor in parallel of the capacitor arrangement is charged to around 5V by the power supply controller.

In preference the capacitor arrangement includes a first and a second capacitor in parallel.

In preference the second capacitor is in communication with a voltage regulator to provide power to the micro-controller.

In preference the electrical relay driver arrangement includes a sensing resistor so as to set the available current value that will pass through the transistor to provide the available current to the electrical coil of the electro-mechanical rely.

In preference the transistor is a field effect transistor (FET).

In preference the power supply controller provides a current path into a gate of the FET such that when the electrical coil is to be energised after being actuated from the boost current established by the micro-controller, current is made available to the gate of the FET, and the available current passes through said FET at a level determined by the sensing resistor in communication with the first capacitor.

In preference the FET reduces current to the electrical relay to maintain the threshold voltage when reached of the single capacitor or each capacitor in parallel of the capacitor arrangement.

In preference when the electrical coil is to be energised the electrical relay driver arrangement utilises a shunting circuit which keeps the voltage of the capacitor arrangement below the set threshold voltage of the first capacitor such that current is maintained to the gate of the FET to keep the FET on, so as to provide continuous pulses of current to the smoothing capacitor at each zero crossing event of the AC mains supply.

Advantageously the power supply controller continues to provide current pulses around the AC mains supply zero crossings but is limited by its own threshold voltage, preferably set at 5V. Accordingly the power supply controller advantageously only provides as much current as the power supply controller voltage regulator and micro-controller require making the arrangement have an extremely low standby power usage while the electrical coil is de-energised.

As is to be expected the initial energising or actuation of the electrical coil is not synchronised with AC mains voltage supply zero crossing of the load circuit as the mechanical contact electrodes have their own inherent lag time to be physically pulled together and accordingly this lag time needs to be taken into consideration if actual physical engagement between the two mechanical contact electrodes is going to be achieved at an AC mains zero crossing.

Accordingly in this invention the micro-controller includes internal logic which is able to function such that the electrical coil will be energised at that opportune moment recognising the inherent lag time for mechanical contact electrode engagement so that the timing will be such that the physical contact between the mechanical contact electrodes happens when voltage levels of the load circuit are at their lowest around zero crossing thereby minimising any possibility of arcing.

The boost of continuous current provided by the boost circuit rather than a pulse per se, quickly pulls the mechanical contact electrodes together and allows the contact closing moment to be determined by the micro-controller.

After the defined boost time has expired the electrical relay driver arrangement then reverts back to being synchronised with the AC mains supply zero crossing for efficiency which will be established through the charging arrangement of the capacitor arrangement working in communication with the power supply controller.

In preference the boost current provided initially to the electrical coil is for a period of around 15-25 ms.

In preference the boost current is provided for a period of around 20 ms.

In preference the boost current is around 50-160 mA

In preference the boost current is around 65 mA with a peak current of around 150 mA.

In preference after the boost current time has expired, energising of the electrical coil reverts back to the power supply controller wherein when the energising of the electrical coil has to be maintained beyond the boost time a shunt circuit is included to work in combination with the capacitor arrangement keeping voltage of the capacitor arrangement below the set threshold voltage thereby allowing current to flow into the gate of the FET maintaining a continuous pulsing of current into the smoothing capacitor to be smoothed across the electrical coil.

Accordingly this electrical relay driver arrangement will provide a means by which rectified AC mains supply will be able to drive a low voltage electromechanical relay.

By including a micro-controller with internal functionality to recognise inherent lag time in the physical closing of the mechanical contact electrodes of the electro-mechanical relay means that the initial energising of the electrical coil will only take place when AC mains supply voltage of the load circuit to which the relay controls is close to or around a zero crossing event and with utilisation of the boost circuit in the preferred embodiment by being able to provide a spurt of high level current between a zero crossing interval will assist in a quick closing of the relay contacts which then, once physical contact between the mechanical contact electrodes has been completed, the electrical relay drive arrangement then reverts back to its efficient mode of operation through the power supply controller which is drawing pulses of power only at AC mains supply zero crossings.

When the electrical coil no longer requires to be energised the voltage threshold level provided for in the first capacitor can be reached thereby shutting off power generation establishing low power usage of electrical relay driver arrangement in standby.

In order now to describe the invention in greater detail a preferred embodiment will be presented with the assistance of the following illustration.

### BRIEF DESCRIPTION OF THE DRAWING

FIG. 1 is a schematic circuit diagram of the electrical relay driver arrangement in a preferred embodiment of the invention.

### DETAILED DESCRIPTION OF THE ILLUSTRATION

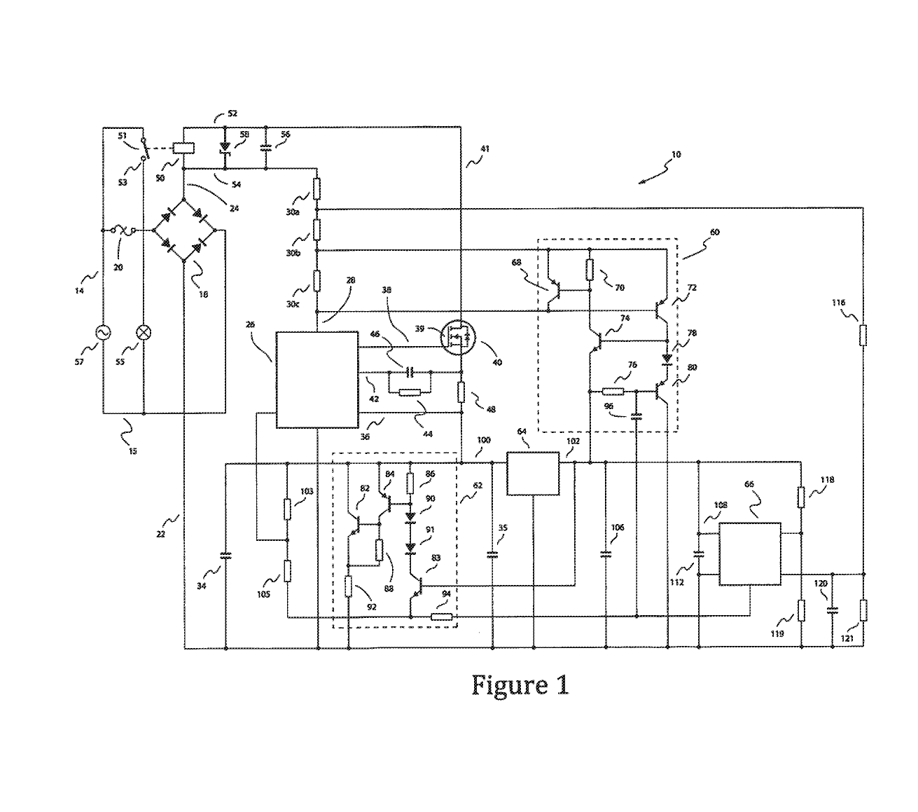

Referring now to FIG. 1 in greater detail wherein the circuit (10) includes AC mains power supply active (14) and neutral (15) into the bridge rectifier (18) wherein the active (14) is separated by thinned track of wire (20) from the bridge rectifier (18). This thin track of wire (20) functions similar as a fuse but takes away the bulkiness and space requirements of factoring in a stand alone fuse into the circuit (10).

The bridge rectifier (18) provides circuit reference (22) allowing positive rectified pulses on (24) wherein the rectified positive pulses (24) through voltage dividers shown as resistors (30a), (30b) and (30c) provide voltage input (28) into the power supply controller (26).

The power supply controller (26) has internal logic functionality in order take the rectified positive AC mains voltage supply pulses (28) and at a selectable voltage, which in the preferred embodiment is 50V or less, to provide a voltage output away from any peak voltages of the rectified positive AC mains voltage supply inputted into the power supply controller (26) such that from 50V or less as the voltage approaches zero crossing and heads back towards 50V, this lower level voltage is outputted in order to charge up capacitors (34) and (35) to a threshold voltage which in the preferred embodiment would be 5V.

Capacitors (34) and (35) are what was described in the summary of the invention as the capacitor arrangement. Capacitors (34) and (35) could have just as easy been a single capacitor with a larger capacitance. In the circuit as capacitor (34) is close to the power supply controller (26) and capacitor (35) close to the voltage regulator (64) powering the microcontroller (66) there is potentially a lowering in the rippling of the current being provided by the respective capacitors (34) (35) as they power the power supply controller (26) and the microcontroller (66) than otherwise would have been expected from a single capacitor. It also allows the use of ceramic capacitors rather than electrolytic capacitors.

Capacitors (34) and (35) provides power (36) through wire (36) to the power supply controller (26) and wherein an output from the power supply controller at (38) to the gate (39) of the field effect transistor (FET) (40), of which switching characteristics will be discussed in greater detail below. Active (14) through the electrical coil (50) to the FET (40) through the sensing resistor (48) provides current to charge capacitors (34 and 35). The electrical coil (50) is connected to the negative line (52) and positive line (54) of the circuit (10) with capacitor (56) and zener diode (58) providing a smoothing effect on the pulsed current being sent through the FET (40) in order to energise the electrical coil (50). The 24V zener diode (58) is for protection of the 24V relay coil (50). Any access current is shunted through the zener diode (58) preventing the coil (50) voltage to exceed 24V.

When the electrical coil (50) forms part of an electro-mechanical relay that is normally open, energizing of the electrical coil (50) creates a magnetic field which will pull a moveable mechanical contact electrode (51) into physical contact with a stationary mechanical contact electrode (53) to complete the electrical load circuit (55) between two power terminals (Ac mains voltage supply) (57) of a load circuit (55) which the electrical mechanical relay controls.

Alternatively if the relay is of a normally closed type, the energizing of the electrical coil to establish the magnetic field results in the physical separation of the two mechanical contact electrodes breaking the electrical circuit between the power terminals for the AC mains supply which is powering the load circuit which the electro-mechanical relay controls.

This invention applies to both types of relays as the soon to be discussed in greater detail micro-controller (66) will be responsible for controlling the timing of the initial contact and/or separation of the mechanical contact electrodes (51) and (53) so as to avoid arcing while during the in between time the energizing of the electrical coil (50) will be through the power supply controller (26) and the pulses that it makes available to the chargeable capacitors (34) and (35) at that interval around AC mains supply zero crossing.

The level of current provided by the FET (40) control switch to the electrical coil (50) is dependent upon the threshold voltage levels set for the capacitors (34) and (35) along with the sensing resistor arrangement primarily resistor (48) in combination with resistor (44) and capacitor (46) through the sensing pathway (42) of the power supply controller (26).

When the threshold voltage of capacitors (34) and (35) is reached the power supply controller (26) stops providing a current on line (38) to the gate (39) of the FET (40) thereby switching off current through the FET (40) on to the electrical coil (50).

When the electrical coil needs to be energized after the micro-controller (66) has initially controlled the boost current to energize the electrical coil (50) through a boost current part of the circuit shown as the broken lines (60) to be discussed in greater detail shortly, the shunt current arrangement shown generally as (62) again by way of broken lines includes bi-polar junction transistors BJT NPN (82), BJT NPN (83) and BJT PNP (84), along with resistors (86), (88), (92) and (94) with diodes (90) and (91) provide a means where the voltage threshold chargeable capacitors (34) and (35) in order to keep the voltage threshold just below the set level, which in the preferred embodiment as introduced above, would be 5V, so that the power supply controller (26) will continue to provide pulses during the set zero crossing interval of 50V or less wherein that charge being placed across the capacitors (34) and (35) through resistor (48) is able to provide pulsed current on the drain side (41) of the FET (40) because as the threshold voltage of capacitors (34) and (35) remains below 5V, a signal or current on line (38) continues to flow from the power supply controller (26) into the gate (39) of the FET (40).

Importantly however, before the electrical coil (50) becomes synchronized with zero crossings of the rectified positive AC mains supply through the switched on FET (40), initial actuation or energizing of the electrical coil (50) is through the boost current through part of the circuit reference by way of dashed or broken lines (60) under the control of the microcontroller (66).

The boost arrangement (60) includes a BJT PNP (68), resistor (70), BJT NPN (74), BJT PNP (72), diode (78), resistor (76) and BJT PNP (80). (96) is a Boost current timing capacitor. This capacitor (96) with resistor (76) determines the amount of time the boost current is applied.

The micro-controller (66) includes internal functionality which recognises the inherent lag time the mechanical contact electrodes (51) and (53) of the electro-mechanical relay have when they are physically pulled together in order to connect the load circuit to the AC mains supply.

The micro-controller (66) is programmed such that timing of the boost current through the arrangement (60) into the electrical coil (50) of the relay will be realized so that physical contact between the mechanical contact electrodes (51) and (53) when first energizing of the electrical coil (50) is required will take place at that moment in time when AC mains supply is at a voltage about a zero crossing.

Boost arrangement (60) provides a boost of current preferably of 65 mA with 150 mA peak capability. 20 ms for a 50 Hz AC mains supply of 100-150 mA.

This burst of 65 mAmA for 20 ms pulls the mechanical contact electrodes (51) and (53) closed very quickly and as introduced above the moment of contact time is timed by the micro-controller taking into regards inherent lag time for the mechanical contact electrodes to come together so this all takes place at a zero crossing moment of the AC mains supply in order to protect the mechanical contact electrodes in order to increase their life expectancy.

After the 20ms boost time has expired the circuit then reverts back to being synchronized with the power supply controller (26) which is utilizing the efficiencies achieved through providing pulsed voltage output (32) at the rectified positive zero crossings or close there to, starting at 50V or less in the preferred embodiment, of the AC mains supply in order to charge the capacitors (34) and (35) and as the shunt arrangement (62) keeps the threshold level of the capacitors (34) and (35) below 5V continued pulses of current are used to energize the electrical coil (50).

The relay coil (50) is in series with the FET (40) wherein 65mA (adjustable in hardware to suit the relay chosen) is shuntable through the shunt arrangement (62). The remainder of the 150mA is available to charge capacitors (34) and (35) to the threshold voltage if required.

When the electrical coil (50) is de-energized the power supply controller (26) continues to provide current pulses around AC mains zero crossing but is now limited by the regulation of its own threshold placed upon capacitors (34) and (35) rather than any established current limit.

As the threshold voltage is reached by capacitors (34) and (35) current (38) into the gate (39) of FET (40) is closed off and the current is removed from electrical coil (50).

The power supply of controller (26) in this circumstance only provides as much current as required through the capacitor (34) to provide power to the power supply controller (26) and through voltage in (100) to the voltage regulator (64), for a regulated output voltage (102) for powering (108) the micro-controller (66). As introduced above (96) is a Boost current timing capacitor. This capacitor (96) with resistor (76) determines the amount of time the boost current is applied. (106) is a supply capacitor for the micro-controller (66). This is the 3.3V supply. (112) is a High frequency bypass capacitor for the micro-controller (66) power supply (108).

The signal through Resistor (116) which feeds into resistor (121) is used to supply the micro-controller (66) with AC mains voltage supply zero crossing information. This signal forms a filtered mains zero crossing signal. That signal is compared with a reference signal provided by the resistors (118) and (119) that form a voltage divider. These two signals are fed into a comparator (not shown) that provides the microcontroller (66) the zero crossing information so that the relay arrangement can be timed to close at or around a mains zero crossing. Capacitor (120) acts as a smoothing capacitor.

Resistors (103) and (105) adjust the power supply controllers threshold voltage from 5V to 4V during the relay opening (de-energising) event to ensure there is no current drawn from the relay coil at this time. It allows for a more predictable opening duration.

1. An electrical relay driver arrangement when used for energising and de-energising an electrical coil of an electro-mechanical relay, said electrical relay driver arrangement including:
an electrical coil of an electro-mechanical relay wherein energising and de-energising of the electrical coil of the electro-mechanical relay controls the supply of power from a AC mains voltage supply to a load circuit
a power supply controller adapted to receive a rectified AC mains voltage supply, said rectified AC mains voltage supply derived from the AC mains voltage supply under the control of the electro-mechanical relay;
said power supply controller further adapted to provide outputtable voltage at definable intervals approaching or about zero crossing of the AC mains voltage supply under the control of the electro-mechanical relay;
said outputtable voltage at definable intervals approaching or about zero crossing of the AC mains voltage supply derived from the AC mains voltage supply under the control of the electro-mechanical relay adapted to charge a capacitor arrangement to a selectable voltage, said capacitor arrangement in communication with a resistor to provide an available current, said power supply controller further including an output to provide a control signal to a transistor, said transistor upon receiving said control signal from said power supply controller provides the available current to the electrical coil of the electro-mechanical relay;
a micro-controller adapted to provide a boost current, wherein said boost current is adapted to energise the electrical coil of the electro-mechanical relay at a determined time whereby mechanical contact electrodes of the electro-mechanical relay are pulled together at a zero crossing interval of the AC mains voltage supply under the control of the electro-mechanical relay when the supply of power from the AC mains voltage supply under the control of the electro-mechanical relay is being supplied to the load circuit,
such that when the electrical coil of the electro-mechanical relay is to be energised, the electrical coil initially receives the boost current at and for a time interval set by the micro-controller and thereafter from the available current provided through the transistor receiving the control signal from the power supply controller.

2. The electrical relay driver arrangement of claim 1 wherein the capacitor arrangement is a single capacitor or a plurality of capacitors in parallel.

3. The electrical relay driver arrangement of claim 1 further including a smoothing capacitor adapted to smooth out the available current to the electrical coil of the electro-mechanical relay.

4. The electrical relay driver arrangement of claim 3 wherein voltage in for the power supply controller is taken directly from the rectified AC mains voltage supply derived from the AC mains voltage supply under the control of the electro-mechanical relay through a series of resistors.

5. The electrical relay driver arrangement of claim 4 wherein the power supply controller charges the single or each capacitor of the capacitor arrangement to a defined voltage.

6. The electrical relay driver arrangement of claim 5 wherein the single or each capacitor of the capacitor arrangement is charged to 5V by the power supply controller.

7. The electrical relay driver arrangement of claim 2 wherein the capacitor arrangement includes a first and a second capacitor in parallel.

8. The electrical relay driver arrangement of claim 7 wherein the second capacitor is in communication with a voltage regulator to provide power to the micro-controller.

9. The electrical relay driver arrangement of claim 1 further including a sensing resistor so as to provide a settable value of the available current that is passable through the transistor to provide the available current to the electrical coil of the electro-mechanical rely.

10. The electrical relay driver arrangement of claim 1 wherein the transistor is a field effect transistor (FET).

11. The electrical relay driver arrangement of claim 10 wherein the power supply controller provides a current path into a gate of the FET such that when the electrical coil has been initially energised from the boost current, current is then made available to the gate of the FET, so as to allow the available current to pass through said FET at a level determined by the sensing resistor.

12. The electrical relay driver arrangement of claim 11 wherein the FET switches off available current to the coil of the electro-mechanical relay when a threshold voltage of a first capacitor in the capacitor arrangement is reached.

13. The electrical relay driver arrangement of claim 12 including a shunting arrangement adapted to keep the voltage of the first capacitor below the threshold voltage of the first capacitor such that current is maintained to the gate of the FET to keep the FET on.

14. The electrical relay driver arrangement of claim 1 wherein the boost current provided initially to the electrical coil is for a period of 12-25 ms.

15. The electrical relay driver arrangement of claim 14 wherein the boost current is provided for a period of around 20 ms.

16. The electrical relay driver arrangement of claim 15 wherein the boost current is around 65 mA

17. The electrical relay driver arrangement of claim 16 wherein the boost current peak is around 150 mA.
